(19) United States
(12) Patent Application Publication
(10) Pub. No.: US 2025/0044030 A1
(43) Pub. Date: Feb. 6, 2025

(54) DEVICE FOR TEMPERING AN OBJECT

(71) Applicant: EBNER Industrieofenbau GmbH, Leonding (AT)

(72) Inventors: Robert EBNER, Leonding (AT); Andreas SAUSCHLAGER, Leonding (AT)

(73) Assignee: EBNER Industrieofenbau GmbH, Leonding (AT)

(21) Appl. No.: 18/846,786

(22) PCT Filed: Mar. 14, 2023
(86) PCT No.: PCT/AT2023/060074

§ 371 Date: Sep. 13, 2024

(30) Foreign Application Priority Data
Mar. 15, 2022 (AT) A50165/2022

(51) Int. Cl. F27B 5/14; C21D 1/767; C21D 9/00; F27B 11/00; F27D 7/04

(52) U.S. Cl. CPC F27B 5/14; C21D 1/767; C21D 9/0006; F27B 11/00; F27D 7/04; F27D 2007/045

(57) ABSTRACT

A device for tempering an object includes a chamber for receiving the object, wherein the chamber is surrounded by a chamber casing, a base element and a cover element, a heating element, a rotor for circulating a first gas, wherein the rotor is arranged in the chamber, and a rotor drive with which the rotor is made to rotate. The heating element is formed by the rotor with the rotor drive.

The invention relates to a device for tempering an object, in particular a metal object, comprising a chamber for receiving the object, wherein the chamber is surrounded by a chamber casing, a base element and a cover element, a heating element, a rotor for circulating a first gas, wherein the rotor is arranged in the chamber, and a rotor drive with which the rotor is made to rotate.

The invention further relates to a method for tempering an object, in particular a metal object, which is put in a device, wherein this device comprises a chamber, which is surrounded by a chamber casing, a base element and a cover element, for receiving the object, wherein the temperature in the chamber is modified with a heating element, and wherein a first gas is circulated in the chamber with a rotor which is arranged in the chamber and the rotor is made to rotate with a rotor drive.

In many industrial furnaces which are used to heat treat various materials, such as, e.g., aluminum, steel, non-ferrous heavy metals, etc., the heat transfer is done by convection. Here, air or other, various protective gases are made to flow onto and/or around the annealing material to be heated and/or cooled. This enables an even and rapid heat treatment of the annealing material.

Hydrogen is often used as a protective gas in particular in the steel industry because the good heat conductivity of hydrogen results in a better heat transfer in comparison to air. In addition, hydrogen also has reducing properties at the surface of the annealing material. The low density of the hydrogen ensures that the fan motor responsible for the convection requires less energy.

Conventionally, the energy input in such plants is done via separate heating coils, wherein the heat conducting material must be exposed to a certain temperature overshoot in order to achieve a heat transfer. This means that the heat conducting material must always be hotter than the furnace temperature.

It is known from the prior art to control a fan motor based on the gas density in a furnace chamber. For example, DE 35 19 994 C1 describes a method for accelerated cooling of annealing material after an annealing operation inside an annealing furnace, in which cooling gas is circulated through the furnace chamber and outside the furnace chamber through a cooler and a circulation fan, wherein the cooling gas is circulated at essentially constant circulation speed at first and, after a specified, essentially temperature-determined mass density of the cooling gas to be accelerated by the circulation fan has been achieved, the circulation speed of the cooling gas is reduced depending on the temperature-dependent increase in mass density. Thus, the cooling time is to be reduced.

U.S. Pat. No. 4,543,891 A describes an annealing device comprising; a fan for circulating hot gas inside the furnace and an electric motor, on which a load is exerted by the fan, and a load transducer for acquiring an electric load at the motor and which is able to generate a load signal; a load change detector, which responds to the load signal and can generate a load change signal; a frequency reference integrator, which responds to the load change signal and is able to generate, to store and to change a reference signal in response to the load change signal; and a drive with adjustable frequency, which responds to the reference signal and is able to supply the motor with an a.c. power with changeable frequency.

The object underlying the present invention is to specify a possibility for tempering an object.

The object of the invention is achieved in the device mentioned in the beginning in that the heating element is formed by the rotor with the rotor drive.

Further, the object is achieved with the method mentioned in the beginning, according to which it is provided that the rotor with the rotor drive is used as heating element.

It is of advantage here that the use of the rotor with the rotor drive as heating element enables a more immediate input of the thermal energy in the circulation gas. In addition, this helps provision simple possibilities of influencing the tempering of an object.

In accordance with one embodiment variant of the invention, it can be provided that the one rotor with the rotor drive is the only heating element, or that multiple rotors with a rotor drive each are arranged and these are the only heating elements. Relinquishing additional heating elements enables a simpler structure of the device. In addition, the above-mentioned effects can be further improved.

In accordance with another embodiment variant of the invention, it can be provided that the chamber casing is surrounded by a support casing and preferably the cover element is surrounded by a support cover element. This enables the durability of the thermally loaded chamber capsule against compressive loads to be reduced, whereby greater freedom in designing this capsule can be created, in particular with respect to a more even distribution of the temperature in the chamber by heat conduction for heating and/or for maintaining a temperature and/or for a quicker heat dissipation by heat conduction for the cooling of the object.

According to another embodiment variant of the invention, it can be provided that a thermal insulation is arranged between the chamber casing and the support casing and preferably between the cover element and the support cover element in order to thereby reduce a transfer of the thermal energy to the support casing and/or the support cover element, whereby the wall thickness in same can be reduced. In addition, this can achieve that the thermal energy, which must be introduced in the chamber via the at least one rotor with the at least one rotor drive in order to achieve a specific, predefinable temperature, can be reduced, as the thermal efficiency of the device can be improved with the thermal insulation.

According to one embodiment variant of the invention, it can be provided for further improvement of these effects that the thermal insulation has multiple layers, whereby boundary surfaces and/or transitional surfaces can be created within the thermal insulation.

Another improvement of these effects can be achieved with another embodiment variant of the invention, according to which the multiple layers consist of substances that are mutually different. This can also achieve a reduction of costs by ensuring that more expensive thermal insulation substances can be provided only in regions with a higher temperature load, whereas more inexpensive insulation substances can be used in regions with already reduced thermal load. In addition, this can also achieve an improved synchronization with the thermal behavior of the device toward the interior and/or toward the exterior.

In accordance with another embodiment variant of the invention, it can be provided that the fan wheel has a first diameter, that the chamber further has a second diameter, and that the first diameter is between 20% and 80% of the second diameter. An enlargement of the fan wheel can increase the power requirement of the electric motor with the fan wheel, whereby also the input of thermal energy in the circulation gas can be increased. For example, a diameter enlargement by 10% increases the power requirement 1.6-fold. Here, it was established during evaluation of the invention that fan wheel diameters in the specified range are of advantage.

According to another embodiment variant of the invention, it can also be provided for increasing the power consumption of the fan wheel with the rotor drive that this embodiment variant of the invention has at least one mixing element for admixing at least one second gas to the first gas. Admixing the second gas enables the density of the circulation gas to be influenced. For example, doubling the density of the circulation gas doubles also the power requirement of the rotor drive.

According to another embodiment variant of the invention, it can be provided for further reducing the compressive load on the chamber casing and the chamber cover, i.e. the interior capsule of the chamber, that at least one pressure measurement element is arranged, so that a pressure acting upon the chamber casing and the cover element from the chamber is unequal by a maximum of 10% to a pressure existing between chamber casing and the support casing and between the cover element and the support cover element. The pressure measurement element can therefore be used to measure a pressure in the chamber and to adapt the pressure acting upon the chamber casing and the chamber cover from the exterior accordingly.

According to an embodiment variant of the method, it can be provided for modifying the temperature in the chamber that this is carried out by a change in the power consumption of the rotor with the rotor drive.

According to other embodiment variants of the method, it can be provided to that end that—as elaborated above—a second gas is admixed to the first gas, which second gas is different from the first gas, and the power consumption is modified by changing the mixing ratio of the two gases and/or that the pressure in the chamber is modified for changing the power consumption of the rotor with the rotor drive and/or that the rpm of the rotor drive and optionally of the rotor is modified for changing the power consumption of the rotor with the rotor drive. For example, a doubling of the rpm of the fan wheel will increase the power requirement of the rotor drive 4-fold.

According to one embodiment variant of the method, a gas whose weight is at least 50% higher than the weight of the first gas is preferably used as second gas for changing the density of the circulation gas.

For the purpose of better understanding of the invention, it will be elucidated in more detail by means of the FIGS. below.

These show in a simplified schematic representation:

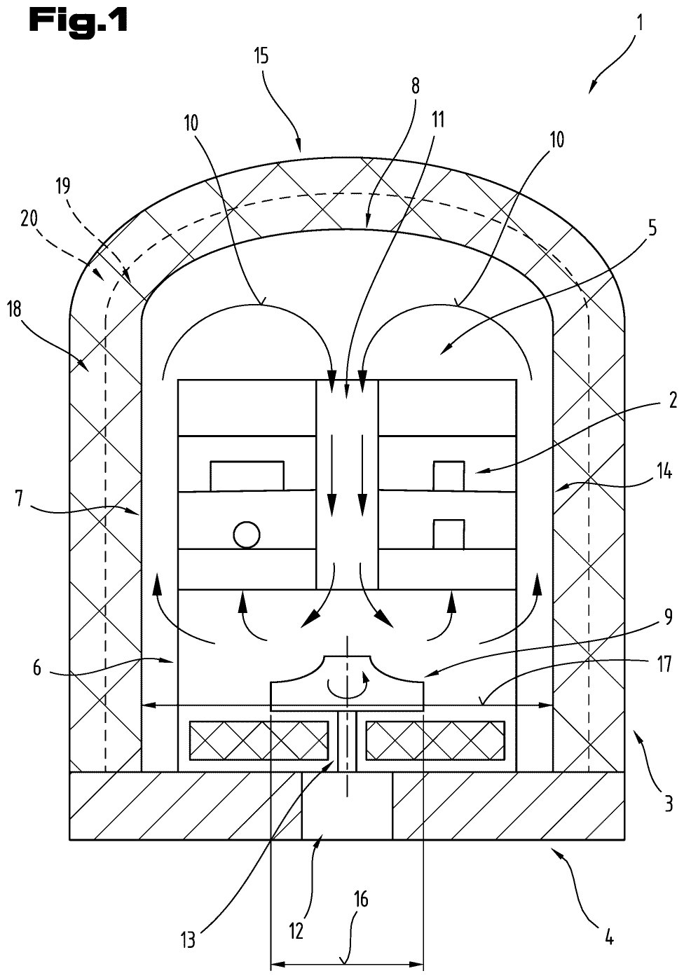

FIG. 1 a device for tempering an object.

First of all, it is to be noted that, in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted FIG., and in case of a change of position, these specifications of location are to be analogously transferred to the new position.

FIG. 1 shows a device 1 for tempering an object 2.

The device 1 is represented as a so-called hood type furnace with a furnace hood 3 and a base element 4. However, the geometry represented of the hood type furnace is not to be understood restrictively. Further, the device 1 can generally also look different than represented in FIG. 1, as long as it is suited for tempering the object 2.

Within the scope of the invention, the term tempering comprises the maintaining of a temperature, the cooling of the object 2 and in particular the heating of the object 2.

The object 2 can be a, in particular metal, product, such as, for example, a metal sheet or a blank, etc., or a raw material, such as, for example, a metal, etc. The operation in the device 1 can be, for example, the melting of the object or a specific reaction in or at or with the object 2, such as, for example, a phase transformation, a hardening of a metal object 2, the tempering of an object, etc. This enumeration is merely exemplary and is not to be understood restrictively. Generally, the device 1 can be used in a thermoprocessing plant in order to process an object 2 thermally, i.e. at increased temperature, with it in batches or continuously.

In a merely exemplary manner, it should also be noted that the device 1 can be used for objects 2 from aluminum and/or an aluminum alloy and/or generally non-ferrous metals (such as light metals of the non-ferrous heavy metals) or from steel.

It is further possible that only one individual object 2 or multiple objects 2 simultaneously are subjected to a thermal treatment in the device.

When the device 1 and/or components thereof are described in more detail below, this does not mean that the device 1 cannot have any other parts and/or components, as known from the prior art in such devices 1. For example, the device 1 can also have various measuring probes, regulating and/or control devices, etc.

The device 1 has a chamber 5 for receiving the object 2 for/during the treatment in the device 1. As can be seen from FIG. 1, also multiple, optionally different, objects 2 can be subjected to the thermal treatment in the device 1 simultaneously. Optionally, the objects 2 can be held on a holding device 6, which can be arranged in the chamber 5.

The chamber 5 is surrounded by the base element 4, a chamber casing 7 and a cover element 8. The chamber casing 7 can be arranged so as to be resting on the base element 4. Further, the cover element 8 can be configured as one piece with the chamber casing 7, as known from hood-type furnaces. Yet, also the base element 4 can be configured as one piece with the chamber casing 7 and optionally with the cover element 8. Here, a closable opening as access to the chamber 5 can optionally be configured in the chamber casing 7 and/or in the cover element 8. The chamber casing 7 can define the volume of the chamber 5 with the cover element 8 and the base element 4.

Further, the device 1 has a rotor 9 (which can also be referred to as ventilator wheel). The rotor 9 is arranged in the chamber 5, in particular below the at least one object 2. The rotor 9 can be arranged above the base element 4 or at least partially inside the base element 4 in a corresponding recess. Preferably, the rotor 9 is arranged between the object 2 and the base element 4.

The rotor 9 serves to circulate a first gas inside the chamber 5 during the thermal treatment of the object 2, as indicated in FIG. 1 by means of flow arrows 10. Here, the circulation can be done such that, for example, the first gas is conducted past the at least one object 2 and flows back down centrally in a direction towards the rotor 9, as shown in FIG. 1. A central flow duct 11 can be provided in the chamber 5 for the central return flow of the first gas. This flow duct 11 can be arranged and/or configured, for example, in the holding device 6 for the at least one object.

Hydrogen (H₂), for example, can be used as first gas. Yet, depending on the thermal treatment of the object to be carried out, the first gas can also be a different gas, for example nitrogen (N₂) and/or a carbon donor gas, such as, for example, carbon dioxide (CO₂), in order to carry out a nitration, carburization or nitrocarburization with it. These gases are to be understood as mere examples, wherein hydrogen is preferably used as first gas for the above reasons if no further reaction with the object 2 is to take place during the thermal treatment.

The first gas can be fed into the chamber 5 via a supply line that is not represented in more detail, optionally following one or multiple purification steps of the chamber atmosphere, for example by a single or multiple evacuation and purging operations of the chamber 5 with a gas, in particular the first gas.

The rotor 9 is operatively connected to a rotor drive 12, for example via an axle 13, so that the rotor can be made to rotate with the rotor drive 12. The rotor drive 12 is in particular an electric motor, yet it can also be formed by another suited drive. Also, the rotor 9 can have a different operative connection to the rotor drive 12, for example via a gear or multiple gears, or a chain drive, etc.

The rotor drive 12 and/or the axle 13 and/or said operative connection can, for example, be at least partially arranged in a recess in the base element 4, as represented in FIG. 1. The rotor drive 12 can also be arranged below the base element 4.

Within the scope of the invention, it is possible for the device 1 to have more than one rotor 9 and more than one rotor drive 12, for example two each or three each, etc. Here, preferably one rotor 9 each is operatively connected to one rotor drive 12 each, for example via one axle 13 each. The multiple rotors 9 can be arranged next to one another in the region of the base element 4. Yet, individual or all rotors can also be arranged in the region of the chamber casing 7 or of the cover element 8 in order to be able to thus create different flow conditions in the chamber 5. The rotor drives 12 assigned correspondingly to the rotors 9 can be arranged in the device 1 accordingly.

The device 1 further has at least one heating element. This heating element is formed by the at least one rotor 9 with the rotor drive 12. In the preferred embodiment variant of the device 1, it is provided that the one rotor 9 with the rotor drive 12 is the only heating element, or that multiple rotors 9 with a rotor drive 12 each are arranged in the device 1 and these are the only heating elements. In contrast to such devices 1 according to the prior art, the energy input therefore is not done via separate heating coils and/or heating elements. In the latter, the heat conducting material must be exposed to a certain temperature overshoot in order to achieve a heat transfer. This means that the heat conducting material must always be hotter than the temperature in the chamber 5. The invention circumvents this disadvantage in that the at least one rotor 9 with the rotor drive 12 is used directly as an energy source (heating source).

While another heating element is preferably not provided in the device 1 for heating the circulation gas in the chamber 5, in a non-preferred embodiment variant, at least one other heating element, which is different from the rotor 9 with the rotor drive 12, can be arranged, for example a resistance heating element or a radiant heating element, which can support the energy input in the circulation gas if required. This at least one additional heating element can be arranged in the chamber 5, for example at the chamber casing 7 or at the cover element 8.

The device 1 can be used to carry out a method for tempering an object 2, in particular a metal object 2, according to which the object 2 is put in the device 1, and wherein the temperature in the chamber is modified with the at least one rotor 9 with the rotor drive 12. Here, the energy input is done directly in the circulation gas in the chamber 5 via the rotor 9 with the rotor drive 12.

For modifying the temperature in the chamber 5, it can be provided that this is modified by changing the power consumption of the at least one rotor 9 with the at least one rotor drive 12. The temperature of the circulation gas in the chamber 5 can be increased as the power requirement of the at least one rotor 9 with the at least one rotor drive 12 increases. Conversely, the temperature the circulation gas in the chamber 5 can be reduced as this power requirement decreases. As the circulation gas in the chamber comes in direct contact with the at least one object, the change in the temperature of the circulation gas can also achieve a change in the temperature of the object.

To modify the power consumption, the density of the circulation gas in the chamber 4 can be modified, for example. As elaborated above, a doubling of the density of the circulation gas in the chamber 5 will double the power requirement of the at least one rotor 9 with the at least one rotor drive 12.

According to one embodiment variant, the density can be modified by admixing at least one second gas to the first gas, for example. The second gas is different from the first gas. In particular, the second gas can have an at least 50% higher weight than the first gas.

Nitrogen or argon, for example, can be used as second gas (unless the first gas is nitrogen or argon). Other suited gases can also be used. Here, the modification of the temperature can be adjusted via the mixing ratio of the two or of the gases, as the power requirement of the at least one fan wheel 9 with the at least one fan drive 12 increases as the density increases, i.e. as the volume fraction of the heavy second gas in the chamber 5 increases. Conversely, the reduction of the volume fraction of the heavy second gas in the chamber 5 can reduce the power requirement of the at least one fan wheel 9 with the at least one fan drive 12.

The specific mixing ratios of the gases in the individual method steps respectively depend on the object 2 to be treated and the kind of thermal treatment of the object. They can be determined by the skilled person with a small number of tests without inventive skill, so that the specification of specific mixing ratios is obsolete.

According to one embodiment variant, the device 1 can have at least one mixing element for admixing at least one second gas to the first gas in order to adjust the desired mixing ratio of the gases used as circulation gas. The mixing element can be, for example, a mixing valve, which can in particular be regulated and/or controlled.

Yet, also separate gas lines for the different gases can be provided in the chamber 5. In this case, the mixing ratio can be regulated and/or controlled by adapting and/or measuring the volume flows of the gases, for example.

Additionally or alternatively, the density change can also be achieved by increasing the pressure and/or reducing the pressure in the chamber 5. The pressure can be increased by feeding more of the first gas and/or of the at least one second gas in the chamber. Therefore, an increase in the pressure in the chamber 5 can increase the power consumption of the at least one fan wheel 9 with the at least one fan drive 12. Conversely, a reduction of the pressure in the chamber 5 can reduce the power consumption of the at least one fan wheel 9 with the at least one fan drive 12.

It should be noted also with respect to this embodiment variant that the skilled person can determine the extent of the pressure increase that is advantageous for the respective application with a small number of tests without inventive skill, so that the specification of a specific pressure is obsolete. It should be noted merely by way of example that the pressure can be between 30 mbar and 80 mbar.

In accordance with one embodiment variant of the device 1, it is of advantage for increasing the pressure in the chamber 5 if the chamber casing 7 is surrounded by a support casing 14 and preferably the cover element 8 is surrounded by a support cover element 15. Here, the support casing 14 can optionally also be supported on the base element 4.

The support cover element 15 can be configured as one piece with the support casing 14. Yet, also the base element 4 can be configured as one piece with the support casing 14 and optionally with the support cover element 15. Here, a closable opening as access to the chamber 5 can optionally be configured in the support casing 14 and/or in the support cover element 15.

This double-shell embodiment of the “capsule” of the chamber 5 has the advantage that it enables the thermally loaded chamber casing 7 and the cover element 8 to be protected from a compressive load. To that end, a first pressure can be applied at the interior face (chamber face) at the chamber casing 7 and of the cover element 8 and a second pressure can be applied at the exterior face (support capsule face) at the chamber casing 7 and of the cover element 8.

According to another embodiment variant of the device 1, it can be provided that at least one pressure measurement element (not represented in FIG. 1) is arranged in and/or at the device 1, so that a pressure acting upon the chamber casing 7 and the cover element 8 from the chamber 5 is unequal by a maximum of 10%, in particular by a maximum of 5%, preferably by a maximum of 2.5%, to a pressure existing between chamber casing 7 and the support casing 14 and between the cover element 8 and the support cover element 15. The at least one pressure measurement element can be used, for example, to determine the differential pressure (the difference between the two pressures), and, depending on the result, to either reduce or increase the pressure existing externally between the chamber casing 7 and the support casing 14 and between the cover element 8 and the support cover element 15. To that end, at least one fluid line, which is not represented in FIG. 1, can lead into this intermediate space between chamber casing 7 and the support casing 14 and between the cover element 8 and the support cover element 15 and at least one fluid line can lead out of this intermediate space.

Nitrogen or argon or a gas mixture thereof or therewith, for example, can be used for provisioning the pressure between the chamber casing 7 and the support casing 14 and between the cover element 8 and the support cover element 15.

It can also be provided that the circulation gas is introduced from the chamber 5 into the intermediate space between the chamber casing 7 and the support casing 14 and between the cover element 8 and the support cover element 15 in order to provide pressure compensation. However, this embodiment variant is not the preferred one, as the support casing 14 and the support cover element 15 are not subject to the same thermal load as the chamber casing 7 and the cover element 8 in the preferred embodiment variant.

Preferably, the pressures applied externally and internally at the chamber casing 7 and at the cover element 8 are identical.

This embodiment of the device also enables a reduction of the wall thickness of the chamber casing 7 and optionally the cover element 8. For example, the chamber casing 7 and optionally the cover element 8 can have a wall thickness between 3 mm and 15 mm.

The support casing 14 and optionally the support cover element 15 can have a wall thickness between 5 mm and 30 mm.

Evidently, also other measurement sensors can be used for measuring the pressures. In addition, also multiple measurement sensors can respectively be provided for measuring said pressures.

The data from the pressure measurement sensors can be processed with a data processing plant for regulating and/or controlling at least one of said pressures.

Another, alternative or additional, possibility for modifying the power consumption of the at least one rotor 9 with the at least one rotor drive 12 is that the rpm of the rotor drive 12 and optionally the rotor 9 is modified. A change of the rpm has the effect of a squared change in the power consumption and therefore subsequently the generation of thermal energy and its feeding in the circulation gas in the chamber 5. For example, a doubling of the rpm of the rotor drive 12 and optionally the rotor 9 can increase the power requirement 4-fold. Therefore, the actual value of the temperature in the chamber and its deviation from the target value can be determined via a regulation and/or control device. Depending on the deviation, the rpm can subsequently be increased or reduced with the regulation and/or control device or in another suited manner, so that more or less thermal energy is available for modifying the temperature of the circulation gas.

In accordance with another embodiment variant of the device 1, the power consumption of the at least one rotor 9 with the at least one rotor drive 12 can be modified, additionally or alternatively to at least one of said possibilities, in that a diameter 16 (maximum external diameter) of the fan wheel 9 is modified. This modification is naturally taken into account preferably already when designing the device 1 and the object 2 to be treated, as the change can be carried out only with great effort during operation of the device. This means that, depending on the requirement for thermal energy for the treatment of the object 2 to be expected, the diameter 16 of the fan wheel 9 is predefined and a fan wheel 9 with the corresponding diameter 16 is installed in the device 1. Here, it has proven advantageous according to one embodiment variant of the device 1 if the fan wheel 9 has a diameter 16 between 20% and 80%, in particular between 40% and 70%, of a second diameter 17 of the chamber 5 (maximum internal diameter of the chamber 5 viewed in the same direction as the diameter 16 of the fan wheel 9).

A modification of the diameter 16 of the fan wheel results in a modification to the fifth power of said power requirement. For example, a diameter increase by 10% results in a 1.6-fold increase in the power requirement.

As can be seen from FIG. 1, it can be provided in the double-shell embodiment variant of the device 1 that a thermal insulation 18 is arranged between the chamber casing 7 and the support casing 14 and preferably between the cover element 8 and the support cover element 15. Preferably, this thermal insulation 18 extends across the entire volume of this intermediate space.

If required, the thermal insulation 18 can also be loaded with the aforementioned pressure, which can be applied as required between the chamber casing 7 and the support casing 14 and preferably between the cover element 8 and the support cover element 15. For example, nitrogen or argon can therefore be applied under pressure to the thermal insulation 18.

The thermal insulation 18 comprises a thermal, or consists of a thermal, insulation material, such as, for example, ceramic fiber materials, mineral wool, graphite, etc.

According to another embodiment variant of the device 1, the thermal insulation 18 can be configured multi-layer, for example comprising a first insulation layer 19 and a second insulation layer 20 resting against it, in particular immediately. The thermal insulation 18 can also have more than two insulation layers.

Here, it can be provided in accordance with another embodiment variant that the multiple insulation layers 19, 20 consist of mutually different substances and/or comprise same. This can modify the thermal insulation properties accordingly. For example, the thermal insulation layer 19 located closer to the chamber casing 7 and the cover element 8 can consist of a substance that has better thermal insulation properties in comparison to the substance of the thermal insulation layer 20. The thermal insulation effect can therefore be designed so as to decrease from the interior to the exterior inside the thermal insulation 18.

Should the device 1 also be used for cooling the object 2, it can be provided that it is flow-connected to an external cooler (heat exchanger) in order to thus reduce the cooling duration. To that end, the circulation gas can be circulated from the chamber 5 via the cooler with corresponding fluid lines.

The device 1 has the advantage that no burners with a flame are required for the thermal treatment of the object 2.

The exemplary embodiments show and/or describe possible embodiment variants, wherein also combinations of the individual embodiment variants with one another are possible.

Finally, as a matter of form, it should be noted that for ease of understanding of the structure of the device 1, these are not necessarily depicted to scale.

### Table of Reference Numbers

1 device
2 object
3 hood
4 base element
5 chamber
6 holding device
7 chamber casing
8 cover element
9 rotor
10 flow arrow
11 flow duct
12 rotor drive
13 axle
14 support casing
15 support cover element
16 diameter
17 diameter
18 insulation
19 insulation layer
20 insulation layer

1. A device (1) for tempering an object (2), in particular a metal object (2), comprising
a chamber (5) for receiving the object (2), wherein the chamber (5) is surrounded by a chamber casing (7), a base element (4) and a cover element (8),
a rotor (9) for circulating a first gas, wherein the rotor (9) is arranged in the chamber (5),
a rotor drive (12) with which the rotor (9) is made to rotate,
and a heating element that is formed by the rotor (9) with the rotor drive (12), wherein the rotor (9) with the rotor drive (12) forms the heating source, wherein the one rotor (9) with the rotor drive (12) is the only heating element, or wherein multiple rotors (9) with a rotor drive (12) each are arranged and these are the only heating elements.

2. (canceled)

3. The device (1) according to claim 1,
wherein the chamber casing (7) is surrounded by a support casing (14) and preferably the cover element (8) is surrounded by a support cover element (15).

4. The device (1) according to claim 3, wherein a thermal insulation (18) is arranged between the chamber casing (7) and the support casing (14) and preferably between the cover element (8) and the support cover element (15).

5. The device (1) according to claim 4, wherein the thermal insulation (18) comprises multiple layers.

6. The device (1) according to claim 5, wherein the multiple layers comprise mutually different substances with different thermal insulation properties.

7. The device (1) according to claim 1, wherein the fan wheel (9) has a first diameter (16), wherein the chamber (5) further has a second diameter (17), and wherein the first diameter (16) is between 20% and 80% of the second diameter (17).

8. The device (1) according to claim 1, further comprising at least one mixing element for admixing at least one second gas to the first gas.

9. The device (1) according to claim 3, wherein at least one pressure measurement element is arranged, so that a pressure acting upon the chamber casing (7) and the cover element (8) from the chamber (5) is unequal by a maximum of 10% to a pressure existing between the chamber casing (7) and the support casing (14) and between the cover element (8) and the support cover element (15).

10. A method for tempering an object (2), in particular a metal object (2), which is put in a device (1), wherein this device (1) comprises a chamber (5), which is surrounded by a chamber casing (7), a base element (4) and a cover element, for receiving the object (2), wherein the temperature in the chamber (5) is modified with a heating element, and wherein a first gas is circulated in the chamber (5) with a rotor (9) which is arranged in the chamber (5) and the rotor (9) is made to rotate with a rotor drive (12), wherein the heating element is formed by the rotor (9) with the rotor drive (12), wherein the rotor (9) with the rotor drive (12) is used as a heating source, wherein the one rotor (9) with the rotor drive (12) is the only heating element, or wherein multiple rotors (9) with a rotor drive (12) each are arranged and these are the only heating elements.

11. The method according to claim 10, wherein the temperature in the chamber is modified by a change in the power consumption of the rotor (9) with the rotor drive (12).

12. The method according to claim 11, wherein a second gas is admixed to the first gas, wherein the second gas is different from the first gas, and the power consumption is modified by changing the mixing ratio of the two gases.

13. The method according to claim 12, wherein a gas whose weight is at least 50% higher than the weight of the first gas is used as the second gas.

14. The method according to claim 11, wherein the pressure in the chamber (5) is modified for changing the power consumption of the rotor (9) with the rotor drive (12).

15. The method according to claim 11, wherein the rpm of the rotor drive (12), and optionally of the rotor (9), is modified for changing the power consumption of the rotor (9) with the rotor drive (12).
